(19) United States
(12) Patent Application Publication
(10) Pub. No.: US 2008/0231993 A1
(43) Pub. Date: Sep. 25, 2008

(54) Head slider having light emission device and optical absorption, method for controlling flying height thereof, and controlling circuit thereof

(75) Inventor: Toshiyuki Matsumura, Kawasaki (JP)

Correspondence Address: GREER, BURNS & CRAIN, 300 S WACKER DR, 25TH FLOOR, CHICAGO, IL, 60606, US

(73) Assignee: Fujitsu Limited, Kawasaki-shi (JP)

(21) Appl. No.: 11/975,488

(22) Filed: Oct. 19, 2007

(30) Foreign Application Priority Data
Mar. 20, 2007 (JP) 2007-071765

(51) Int. Cl. G11B 5/60

(52) U.S. Cl. 360/234.3

(57) ABSTRACT

The present invention relates to a head slider used for a magnetic storage device. The head slider includes a light emission device, and an optical absorption device disposed at a position capable of absorbing energy of light emitted by the light emission device.

### BACKGROUND OF THE INVENTION

1. Technical Field

The present invention relates to a head slider used for a magnetic storage device.

2. Description of the Related Art

Associated with progress of storage techniques in recent years, magnetic storage devices, such as HDD (hard disk drives), are being used in various applications including a video recorder, a portable music player, a car navigation system, a gaming machine and a portable phone, in addition to an external storage device for personal computers and servers as a conventional application, and are demanded to have an increased recording density. For increasing the recording density of a magnetic storage device, it is necessary to improve performances of a magnetic head and a magnetic disk as a recording medium.

It has been known that decrease of the distance between a magnetic disk and a head slider for flying a magnetic head above the magnetic disk, i.e., a so-called flying height of the head slider, is significantly effective for increasing the recording density of the magnetic storage device. This is because the effective read signal output of the magnetic disk and the effective intensity of the write magnetic field of the write head element of the magnetic head mounted on the head slider are improved by decreasing the flying height of the head slider. In recent years, accordingly, a DFH (dynamic fly height) technique, which is also known as a TFC (thermal fly-height control) technique, is proposed, in which a thin film copper (Cu) heater mounted on a magnetic head is electrified to expand the magnetic head due to heat developed by the heater, whereby the head slider is protruded to decrease the flying height.

The flying height of the head slider is as extremely low as about 10 nm even in the case where the heater mounted on the magnetic head mounted on the head slider is not electrified. Upon protruding the head slider with heat developed by the heater from the extremely low flying height, it is necessary to control a protrusion distance with high accuracy. However, since copper as the material of the heater has a considerably high thermal conductivity of 398 W/m·K, the heating area extends over a wide range of the magnetic head and the head slider having the magnetic head mounted thereon. The magnetic head is constituted by plural layers formed of different materials with different shape, which are different in expansion coefficient and heat dissipation properties. Since the magnetic head has a thin film coil in the write head element for generating the write magnetic field, the protrusion amount due to expansion of the magnetic head occurring by heating of the thin film coil is accumulated. Accordingly, control of the flying height of the head slider utilizing the heater becomes significantly difficult.

As for the aforementioned problem where the heating area created by the heater extends over a wide range of the magnetic head and the head slider, the heating area due to thermal conduction is suppressed by improving the heat dissipation or liberation property of a magnetic shield layer adjacent to the heater by increasing the volume of the magnetic shield layer. However, these measures are still insufficient, and the increase in volume of the magnetic shield layer is disadvantageous in view of production cost.

In controlling the protrusion amount of the head slider due to heating of the thin film coil of the write head element of the magnetic head in the current situation, the electric power for the heater is set in only two cases, i.e., the case where a voltage is applied to the thin film coil of the write head element, and the case where no voltage is applied thereto (as described, for example, http://www.hitachigst.com/tech/techlib.nsf/techdocs/98EE13311A54CAC8862571710 05E0F16, as a non-patent reference.)

However, specifications for an ordinary magnetic storage device have a wide range of operational temperature of from 5 to 55° C., and the head slider is expanded within the environmental temperature range to fluctuate the flying height. As it is now, no method has been proposed for controlling the flying height of the head slider depending on changes in the environmental temperature.

In order to solve the problem, the invention provides a heating mechanism with a material having low thermal conductivity, and a mechanism for controlling a flying height of a head slider in consideration of heating of a thin film coil of a write head element of a magnetic head and compensating for fluctuation in flying height depending on change in environmental temperature.

### SUMMARY

In accordance with an aspect of an embodiment, a head slider has a light emission device, and an optical absorption device disposed at a position capable of absorbing the energy of light emitted by the light emission device.

### BRIEF DESCRIPTION OF THE DRAWINGS

FIG. 1 is a schematic diagram showing an internal constitution of a magnetic storage device using a head slider according to a first embodiment as a typical embodiment of the present invention;

FIG. 2 is a cross sectional diagram showing the head slider and a magnetic head of the first embodiment;

FIG. 3 is a diagram showing the head slider and the magnetic head of the first embodiment viewed from an air bearing surface;

FIG. 4 is a cross sectional diagram showing a head slider and a magnetic head having a conventional heater mechanism for comparison to the first embodiment;

FIG. 5 is a graph showing a method of controlling the flying height of the head slider of the first embodiment;

FIG. 6 is a block diagram showing control of the head slider of the first embodiment.

### DETAILED DESCRIPTION OF THE EMBODIMENT

An embodiment will be described below. A head slider has, as a control mechanism of the flying height of the head slider, a light emission device disposed on the head slider, an optical absorption device, which is, for example, a semiconductor, disposed adjacent to the light emission device, and a piezoelectric device disposed adjacent to the optical absorption device. The light emission device emits light toward the optical absorption device. The optical absorption device is expanded through optical absorption effect of the semiconductor to decrease the flying height of the head slider. At this time, a voltage developed through the piezoelectric effect of the piezoelectric device disposed adjacent to the optical absorption device is detected to enable quantitative determination of the expansion amount of the optical absorption device, i.e., the flying height of the head slider. The optical absorption effect referred to herein is such an effect in that an electron in a low energy level transits to a high energy level upon absorption of energy externally fed.

The change in the protrusion amount of the head slider caused by change in environmental temperature and heating of the thin film coil of the write head element of the magnetic head mounted on the head slider can be detected through piezoelectric effect by providing the piezoelectric device. Accordingly, the absolute flying height of the head slider, which includes the protrusion amount of the optical absorption device and the fluctuation in flying height of the head slider depending on the change in environmental temperature and the heating of the thin film coil of the write head element, can be quantitatively determined. Consequently, the flying height can be controlled by switching light emission of the light emission device corresponding to the flying height of the head slider.

In general, a light emission device, an optical absorption device constituted by a semiconductor, and a piezoelectric device can be produced without use of a material having a high thermal conductivity, such as copper and silver. Accordingly, the volume of the magnetic shield layer need not be increased excessively as compared to a conventional magnetic head having a thin film heater formed of copper, and thus the production cost of the magnetic head mounted on the head slider can be reduced.

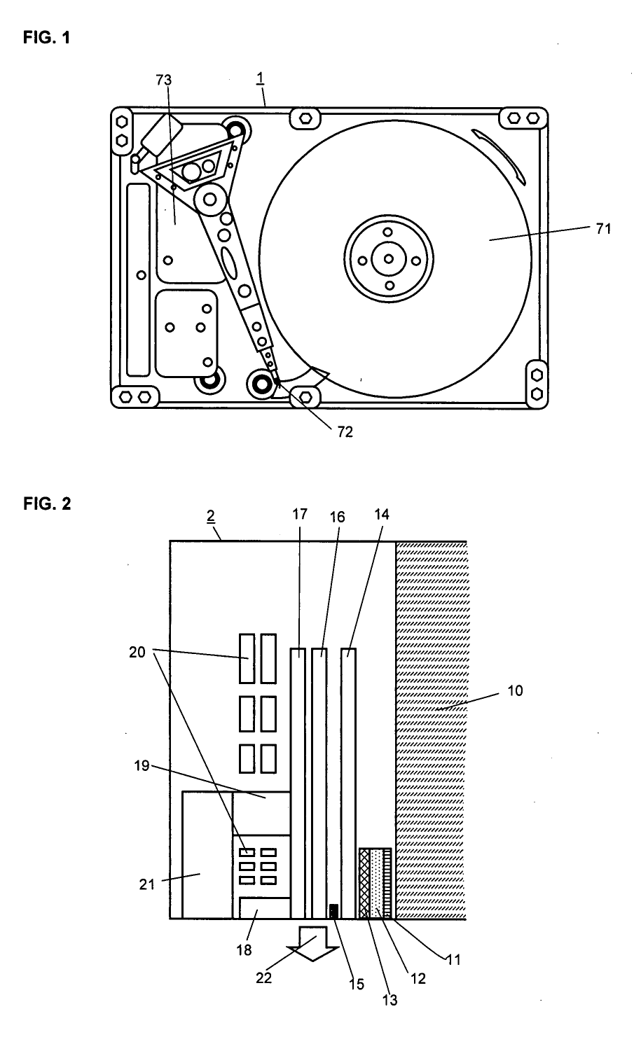

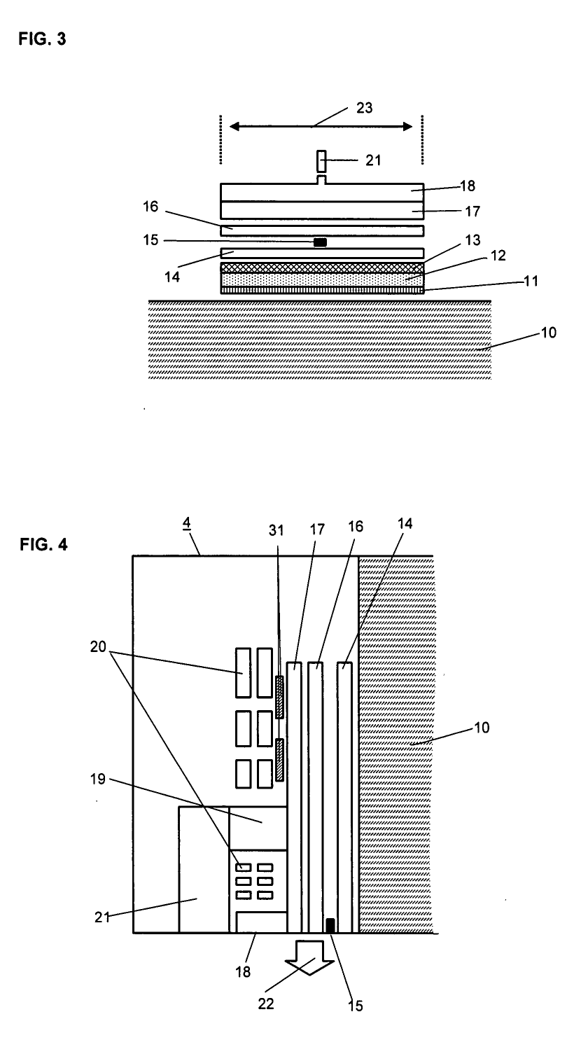

A specific embodiment of the invention will be described below with reference to FIGS. 1 to 6. FIG. 1 is a schematic diagram showing an internal constitution of a magnetic storage device 1 using a head slider according to a first embodiment as a typical embodiment of the invention. The magnetic storage device 1 has inside a magnetic disk 71 as a recording and reproducing medium, a head slider 72 having a magnetic head mounted thereon, and a head amplifier IC 73 for controlling a recording and reproducing signal and supplying electric power to the magnetic head. FIG. 2 is a cross sectional diagram showing the head slider and the magnetic head of the first embodiment, and FIG. 3 is a diagram showing the head slider and the magnetic head of the first embodiment viewed from the air bearing surface of the magnetic head. As in FIGS. 2 and 3, on an alumina-titanium carbide (Al₂O₃—TiC) layer 10 having a thickness of about 2 mm as a head slider portion, an alumina (Al₂O₃) layer having a thickness of about 2.0 μm is formed by a sputtering method as an insulator layer, which is not shown in the figures. In FIG. 3, the magnetic head has a width 23 of about 60 μm.

A light emission device 11 is then disposed on the insulator layer. The light emission device 11 can be selected from a semiconductor laser, a light emitting diode and the like. In the first embodiment, a semiconductor laser is particularly preferably used. This is because since light emission of a semiconductor laser is performed mainly through light emission process referred to as induced emission, coherent light (light having uniform wavelength and phase) can be obtained to provide excellent directivity and energy convergence.

The material for the semiconductor laser can be selected from such materials as InGaAlP, GaAlAs and InGaAsP. In order to perform optical absorption effect with an optical absorption device 12 constituted by a semiconductor described later, the energy of light emitted by the light emission device 11 is necessarily larger than the energy gap of the semiconductor of the optical absorption device 12. Examples of the combination of the optical absorption device 12 and the light emission device 11 satisfying the requirement include a combination of a GaAs (gallium-arsenic) optical absorption device (energy gap: 1.43 eV) and a pn semiconductor light emission device of GaAlAs (gallium-aluminum-arsenic)/InGaN (indium-gallium-nitrogen) (energy: 3.1 eV).

In the first embodiment, the light emission device 11 of a GaAlAs semiconductor laser having a thickness of about 10 μm is formed by an ordinary method, such as a thermal diffusion method, an ion implantation method and an epitaxial (gas epitaxial growth) method. While not shown in the figures, the semiconductor laser light emission device 11 is covered with a light reflection layer except for the light emission surface, i.e., the surface facing the optical absorption device.

The optical absorption device 12 having a thickness of about 5 μm constituted by a semiconductor is disposed adjacent to the light emission device 11. The material of the semiconductor of the optical absorption device 12 can be selected from such materials as, GaAs and AlGaAs. In the first embodiment, a GaAs semiconductor is selected since it has an energy gap that is lower than the energy of light emitted by the light emission device 11.

A piezoelectric device 13 having a thickness of about 10 μm is disposed adjacent to the optical absorption device 12. The material of the piezoelectric device 13 can be selected from such materials as LiTaO₃ and NbTiO₃, and LiTaO₃ is selected in the first embodiment. While not shown in the figures, a pair of electrodes are formed with respect to the light emission device 11 and the piezoelectric device 13, respectively.

While not shown in the figures, the space between a lower magnetic shield layer 14 and the alumina-titanium carbide layer 10 is filled, for example, with an epoxy resin having a surface covered with a silicon oxide film, or alumina. Thus, the protruding mechanism has been completed. The magnetic head of the first embodiment can be produced according to the ordinary method for producing a magnetic head. The protrusion direction of the head slider is shown by the arrow 22 in FIG. 2.

In order to suppress the influence of unnecessary read signal from the magnetic disk, the lower magnetic shield layer 14 having a thickness of about 2.0 μm formed of a Ni—Fe alloy is formed by an ordinary plating method. Thereafter, a read head element 15 having GMR or TuMR magnetoresistance effect is formed by an ordinary sputtering method, and then an upper magnetic shield layer 16 having a thickness of about 1.5 μm formed of a Ni—Fe alloy is formed. While not shown in the figures, the space between the lower magnetic shield layer 14 and the upper magnetic shield layer 16 is filled with alumina.

An insulator layer having a thickness of about 0.26 μm formed of alumina is formed on the upper magnetic shield layer 16, and then a write head element is formed. The write head element has a first lower magnetic pole layer 17 having a thickness of about 1.0 μm, a second lower magnetic pole layer 18 having a thickness of about 4.3 μm, a junction portion 19 having a thickness of about 5.0 μm, a thin film coil 20 having a thickness of about 1.8 μm, and an upper magnetic pole layer 21 having a thickness of about 5.0 μm, which are formed by an ordinary plating method. The members of the write head element can be processed into desired shapes by such techniques as ion milling and photolithography. While not shown in the figures, the spaces including those within the thin film coil 20 and the gaps among the second lower magnetic pole layer 18, the junction portion 19 and the upper magnetic pole layer 21 are filled with alumina. In other words, all the spaces that are not specified in FIG. 2 are filled with alumina.

FIG. 4 is a cross sectional diagram showing a head slider and a magnetic head having a conventional heater mechanism for comparison to the first embodiment. Thin film heaters 31 formed of copper by a plating method are disposed between a first lower magnetic pole layer 17 and a thin film coil 20. All the spaces that are not specified in FIG. 4 are filled with alumina.

The thermal conductivity of the protruding mechanism of the head slider of the first embodiment and that of the conventional head slider are calculated by simulation. As a result of simulation, the thermal conductivity of copper in the heater mechanism of the conventional head slider is 398 W/m·K, and the thermal conductivity of the protruding mechanism of the first embodiment is 42 W/m·K. That is, the thermal conductivity can be reduced by 90%. Accordingly, it is necessary to increase the volume of the magnetic shield layer of the magnetic head mounted on the head slider having the conventional heater mechanism, but the magnetic head of the first embodiment is free of the necessity, and the production cost can be reduced.

FIG. 5 is a graph showing an embodiment of a method of controlling the flying height of the head slider of the first embodiment. The point 41 shows the flying height when the light emission device 11 is not electrified, at which point the voltage of the piezoelectric device 13 is zero since no piezoelectric effect occurs. A voltage is applied to the light emission device 11 to emit light, whereby the optical absorption device 12 is expanded to lower the flying height to the target set value shown by 42. At this time, the change in flying height of the head slider caused by expansion of the optical absorption device 12 is quantitatively determined with the voltage obtained through piezoelectric effect of the piezoelectric device 13. That is, the optical absorption device is expanded until the voltage reaches the set voltage shown by 43. The method for calculating the relationship between the change amount of the voltage obtained through piezoelectric effect of the piezoelectric device 13 and the change amount of the flying height of the head slider will be described. For example, after producing the head slider, the relationship between the change in voltage obtained through piezoelectric effect of the piezoelectric device and the change in flying height is measured with a flying height measuring apparatus, and the resulting relationship is used. In an alternative, the flying height of the head slider, which has been installed in a magnetic storage device, is lowered intentionally until the head slider is in contact with the magnetic disk, and the relationship obtained at that time between the change amount of the output reproduction waveform and the change in voltage obtained through piezoelectric effect is used.

The case where the flying height of the head slider is lowered in excess to the point 44 due to change in environmental temperature or heating of the thin film coil of the write head element will be described. In this case, since the voltage of the piezoelectric device 13 is also increased to the point 45 associated therewith, the voltage applied to the light emission device 11 is turned off until the flying height is returned to the target value 46, i.e., until the voltage of the piezoelectric device is returned to the target value 47. Accordingly, the use of the piezoelectric effect of the piezoelectric device 13 enables control of the absolute flying height of the head slider, which includes not only the protrusion amount of the head slider provided by the optical absorption device but also the protrusion amount of the head slider caused by the change in environmental temperature and the heating of the thin film coil of the write head element mounted on the head slider.

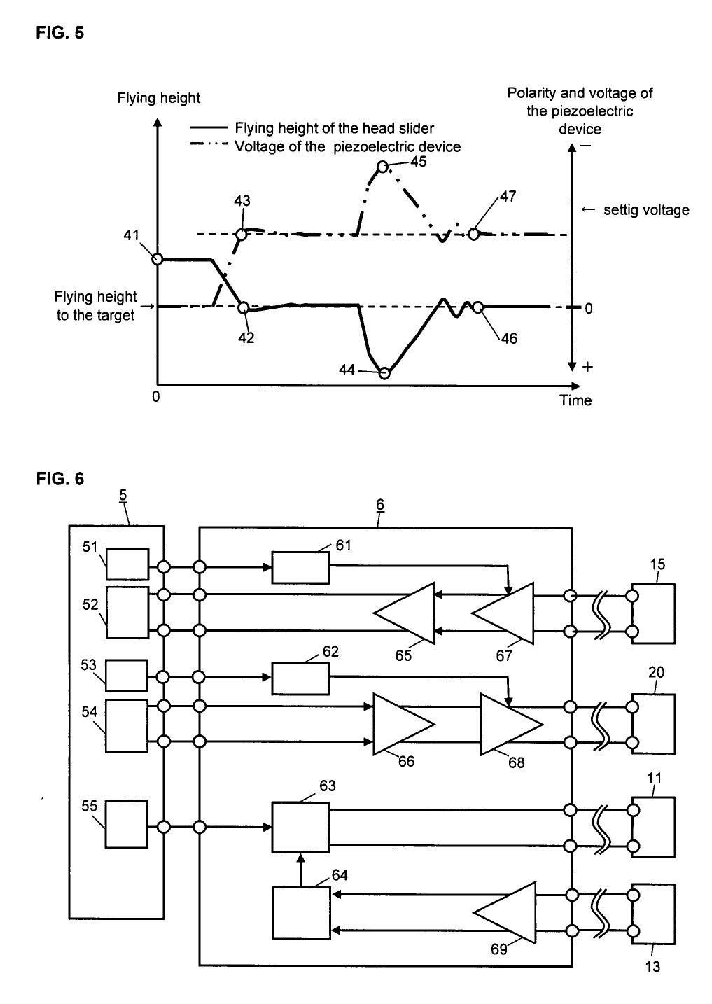

FIG. 6 is a block diagram showing control of the head slider of the first embodiment. An encoder 54 of a read-write channel LSI 5 encodes write data and sends the write data to a write data buffer 66 disposed in a head amplifier IC 6 and transmits it through a write driver 68, and a write magnetic field is applied from the upper and lower magnetic pole layers 17 and 21 through the thin film coil 20 to execute a recording operation. Electric power for the thin film coil 20 is applied from a write voltage regulator 53 through a write electric power controller 62. A decoder 52 of the read-write channel LSI 5 has a function of decoding read data received from a read data buffer 65. The reproducing operation is executed in such a manner that a read signal of the magnetic disk obtained through the read head element 15 is amplified by a read amplifier 67 and sent to the read-write channel LSI 5 through the read data buffer 65. Electric power for the read head element 15 is applied from a read voltage regulator 51 through a read electric power controller 61.

A controlling circuit that controls the flying height of the head slider of the first embodiment will be described. An embodiment where the controlling circuit is disposed inside the head amplifier IC 6 will be described herein. A light emission device electric power controller 63 is disposed for supplying electric power to the light emission device 11. The light emission device electric power controller 63 may be the same as the read electric power controller 61 and the write electric power controller 62. The light emission device electric power controller 63 is connected to electrodes of a light emission device electric power regulator 55 and the light emission device 11. A voltage monitor 69 is disposed. The voltage monitor 69 may have a function of an ordinary voltmeter capable of monitoring voltage. The piezoelectric device 13 is connected to the voltage monitor 69. A light emission device driver 64 is used to control on/off switching of the light emission device electric power controller 63 depending on the voltage value sent from the voltage monitor 69. The flying height controlling system of the head slider shown in FIG. 5 can be attained by using the controlling circuit described herein. The controlling circuit that controls the flying height of the head slider may be disposed inside the read-write channel LSI 5 or may be disposed independently to connect the read-write channel LSI 5 and the head amplifier IC 6.

According to the constitution of the embodiment of the invention, the production cost of the magnetic head can be reduced, and the reliability of the magnetic storage device can be improved. In addition, the flying height of the magnetic head can be decreased to attain high-density recording.

The head slider and the magnetic head in the embodiment of the invention have been described with reference to a magnetic head for longitudinal magnetic recording, but can be used for a magnetic head for perpendicular magnetic recording and for a head slider and a magnetic head for optical magnetic recording.

While the principles of the invention have been described above in connection with specific apparatus and applications, it is to be understood that this description is made only by way of example and not as a limitation on the scope of the invention.

What is claimed is:

1. A head slider comprising:
a light emission device; and
an optical absorption device disposed at a position capable of absorbing energy of light emitted by the light emission device.

2. The head slider according to claim 1, wherein the head slider further comprises a piezoelectric device disposed at a position capable of detecting an expansion amount of the optical absorption device.

3. The head slider according to claim 1, wherein the light emission device comprises a semiconductor laser or a light emitting diode.

4. The head slider according to claim 1, wherein energy of light emitted by the light emission device is larger than an energy gap of the optical absorption device.

5. The head slider according to claim 1, wherein the optical absorption device comprises a semiconductor.

6. The head slider according to claim 2, wherein the head slider comprises a non-magnetic support having formed thereon in this order the light emission device, the optical absorption device and the piezoelectric device.

7. The head slider according to claim 2, wherein the light emission device, the optical absorption device and the piezoelectric device have a thermal conductivity that is smaller than Cu (copper).

8. A method for controlling a flying height of a head slider of a magnetic storage device, the method comprising steps of:
emitting light from a light emission device disposed on the head slider directed to an optical absorption device;
expanding the optical absorption device through optical absorption effect; and
quantitatively determining an expansion amount of the optical absorption device through piezoelectric effect of a piezoelectric device.

9. The method for controlling a flying height of a head slider of a magnetic storage device according to claim 8, wherein the expansion amount of the optical absorption device is quantitatively determined through piezoelectric effect of a piezoelectric device that is disposed adjacent to the optical absorption device to control the flying height.

10. A magnetic storage device comprising:
a magnetic head mounted on a head slider comprising a light emission device and an optical absorption device disposed at a position capable of absorbing energy of light emitted by the light emission device; and
a magnetic disk as a recording medium.

11. The magnetic storage device according to claim 10, wherein the head slider further comprises a piezoelectric device that is disposed adjacent to the optical absorption device.

12. The magnetic storage device according to claim 10, wherein the magnetic storage device comprises a unit that detects a voltage of a piezoelectric device and a unit that controls emission of light of the light emission device depending on the detected voltage, and comprises a controlling circuit in which the optical absorption device is expanded by controlling emission of light of the light emission device to control a flying height of the head slider.
